(19) United States
(12) Patent Application Publication
(10) Pub. No.: US 2011/0226003 A1
(43) Pub. Date: Sep. 22, 2011

(54) Portable Cooler Having an Extendable Drawer System

(76) Inventors: Dustin Chaney, Lumberton, TX (US); Greg Devillier, Beaumont, TX (US)

(21) Appl. No.: 12/725,196

(22) Filed: Mar. 16, 2010

(51) Int. Cl. F25D 3/08; A45C 5/14; B62B 1/16; B62B 1/10; F25D 3/06

(52) U.S. Cl. 62/457.7; 280/47.26

(57) ABSTRACT

A portable system for storing refrigerated or heated items. In some embodiments, the system includes an insulated housing and a drawer system slideably disposed therein. The insulated housing has a lid that is movable between an open position and a closed position. The drawer system has a storage cavity wherein the refrigerated or heated items are received and is movable relative to the insulated housing between a stowed position and an extended position. The storage cavity and the items stored therein are accessible when the lid is in the closed position and the drawer system is in the extended position.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

The disclosure relates generally to portable coolers. More particular, the disclosure relates to a portable cooler with an extendable drawer system.

Conventional coolers, including those manufactured by The Coleman Company, Inc. and Igloo Products Corporation, are used to transport and refrigerate foodstuffs, beverages, and/or other perishable items. Each cooler has an insulated housing forming a storage cavity for receiving items requiring refrigeration and ice. The insulated housing includes a containment portion and a lid. The containment portion generally includes a base and four sides extending vertically therefrom, forming the storage cavity. The free edges of the sides define an opening to the storage cavity. The lid may be coupled to the containment portion over the opening to enclose the storage cavity, and decoupled at least to a degree from the containment portion to enable access through the opening to the storage cavity.

This common design configuration requires that the storage cavity be accessed through the top of the cooler. As is well known, other items, such as luggage, are often stored on top of the cooler during transport. Upon arrival at a particular destination, such as a baseball game or a campground, the cooler often functions as a seat. In both situations, access to the storage cavity is prevented due to the opening of the lid being obstructed. To access the storage cavity, objects stored thereon must be moved from the cooler to enable the lid to be removed from the containment portion. Similarly, an individual seated on the cooler must move from the lid to enable access to the cooler contents. As such, accessing the storage cavity in these circumstances can be inconvenient.

It is known to have a cabinet with a cooler chest in the form of a retractable drawer container within the cabinet. The retractable drawer retracts into and out of the front of the cabinet. The drawer serves as the only access since no lid is provided. Typically the cabinet is also used for sitting with the person having their legs extending over the front of the retractable drawer thereby obstructing the drawer and requiring the person to stand up to allow access to the drawer.

The present invention overcomes the deficiencies of the prior art.

### SUMMARY OF THE DISCLOSURE

A portable system for storing refrigerated or heated items is disclosed. In some embodiments, the system has an insulated housing and a drawer system slideably disposed therein. The insulated housing includes a lid that is movable between an open position and a closed position. The drawer system includes a storage cavity for receiving the refrigerated or heated items. Further, the drawer system is movable relative to the insulated housing between a stowed position and an extended position. The storage cavity is accessible when the lid is in the closed position and the drawer system is in the extended position.

In some embodiments, the system has an insulated housing and a storage cavity disposed therein. The storage cavity contains the refrigerated or heated items. The insulated housing has an exterior base, four exterior walls extending substantially normally to the exterior base, and a lid, wherein the four exterior walls include an exterior front wall, an exterior rear wall opposite the exterior front wall, an first exterior end wall extending between the exterior front and rear walls, and a second exterior end wall opposite the first exterior end wall. The lid is moveable to expose a first opening through which the storage cavity is accessible. Also, the second exterior end wall is moveable relative the exterior base, the exterior front wall, and the exterior rear wall to expose a second opening through which the storage cavity is accessible.

In some embodiments, the system includes an insulated outer housing, an inner housing disposed therein, and a pair of drawer slides coupled therebetween. The insulated outer housing has a base, a lid opposite the base, a front wall, a rear wall opposite the front wall, and an end wall extending between the front and rear walls. The lid is coupled to the rear wall and movable between an open position and a closed position. The inner housing has a base, a front wall, a rear wall opposite the front wall, an interior end wall extending between the front and rear walls, and an exterior end wall opposite the interior end wall, wherein the exterior end wall is insulated and wherein the base, the front wall, the rear wall, the interior end wall, and the exterior end wall define a storage cavity receiving the refrigerated or heated items. The drawer slides enable the inner housing to slide relative to the outer housing between a stowed position and an extended position. The storage cavity is accessible when the lid is in the closed position and the inner housing is in the extended position.

Thus, embodiments described herein comprise a combination of features and characteristics intended to address various shortcomings associated with certain prior portable coolers. The various characteristics described above, as well as other features, will be readily apparent to those skilled in the art upon reading the following detailed description of the preferred embodiments, and by referring to the accompanying drawings.

### BRIEF DESCRIPTION OF THE DRAWINGS

For a detailed description of the disclosed embodiments, reference will now be made to the accompanying drawings in which:

FIG. 1 is a perspective view of a portable cooler having an extendable drawer system in accordance with the principles disclosed herein;

FIG. 2 is a top view of the cooler of FIG. 1 with the lid open;

FIG. 3 is a perspective view of the cooler of FIG. 1 with the lid closed and the drawer system extended;

FIG. 4 is a front view of the cooler of FIG. 1;

FIG. 5 is a rear view of the cooler of FIG. 1;

FIGS. 6 and 7 are views of opposing ends of the cooler of FIG. 1 and the drawer system removed;

FIG. 8 is a top view of the cooler of FIG. 1 with the lid closed;

FIG. 9 is a bottom view of the cooler of FIG. 1;

FIG. 10 is an end view of the outer housing with the lid open;

FIG. 11 is a front view of the cooler of FIG. 1 with the lid closed and the drawer system extended from the outer housing;

FIG. 12 is a front view of the drawer system; and

FIG. 13 is a top view of the cooler of FIG. 1 with the lid open and the drawer system removed from the outer housing.

### DETAILED DESCRIPTION OF THE DISCLOSED EMBODIMENTS

The following description is directed to exemplary embodiments of a portable cooler with an extendable drawer system. The embodiments disclosed should not be interpreted, or otherwise used, as limiting the scope of the disclosure, including the claims. One skilled in the art will understand that the following description has broad application, and that the discussion is meant only to be exemplary of the described embodiments, and not intended to suggest that the scope of the disclosure, including the claims, is limited to those embodiments.

Certain terms are used throughout the following description and the claims to refer to particular features or components. As one skilled in the art will appreciate, different persons may refer to the same feature or component by different names. This document does not intend to distinguish between components or features that differ in name but not function. Moreover, the drawing figures are not necessarily to scale. Certain features and components described herein may be shown exaggerated in scale or in somewhat schematic form, and some details of conventional elements may not be shown in interest of clarity and conciseness.

In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct connection. Thus, if a first device couples to a second device, that connection may be through a direct connection, or through an indirect connection via other devices and connections.

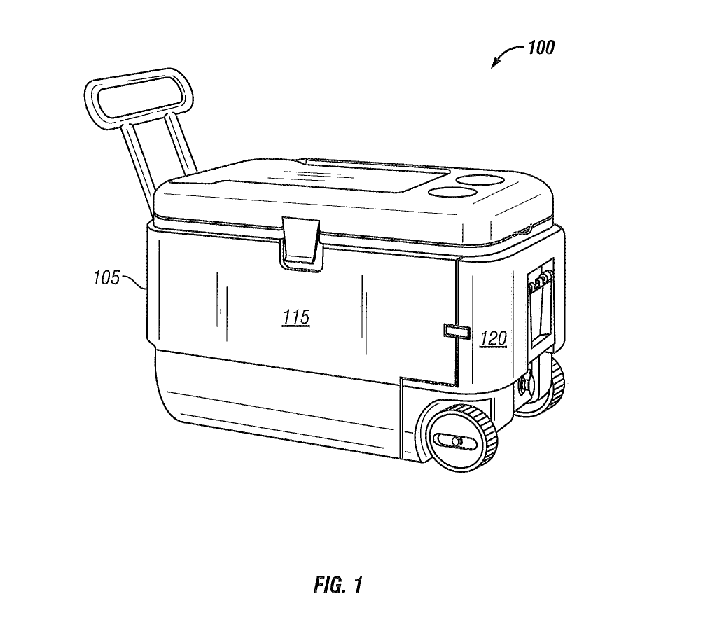

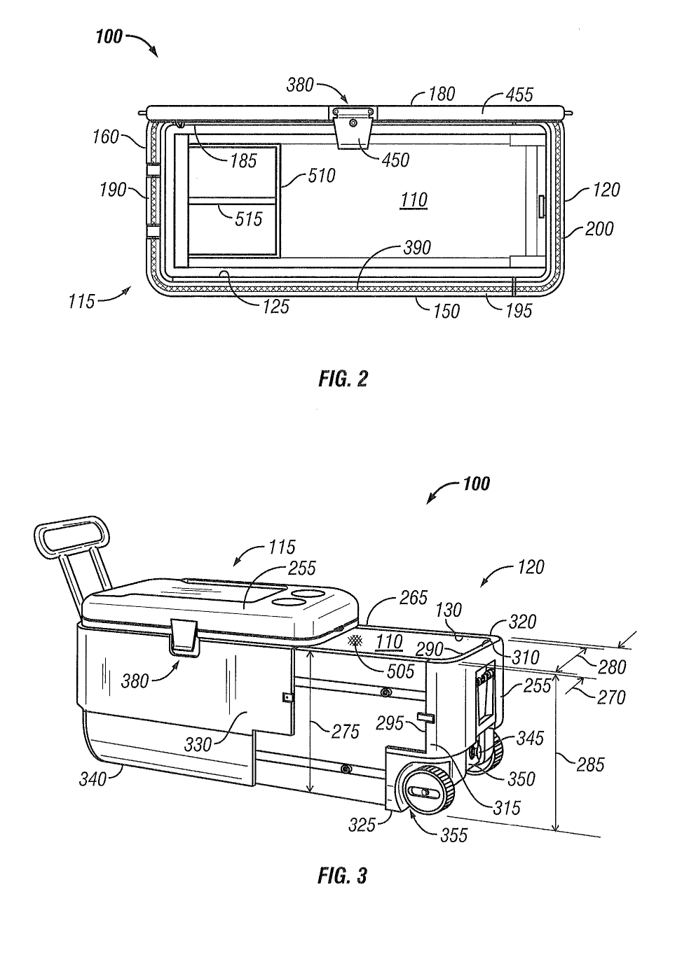

Referring now to FIG. 1, there is shown a portable cooler 100 in accordance with the principles disclosed herein. Cooler 100 includes a housing 105 forming an interior storage cavity 110 (FIG. 2) wherein foodstuffs, beverages, and/or other perishable items may be stored. Housing 105 is insulated, or formed of a material(s) having a low thermal conductivity. Consequently, heat transfer through housing 105 is inhibited, enabling items refrigerated within storage cavity 110 via ice or other equivalent cooling means to remain cold for extended periods of time. Although portable cooler 100 is described in the context of refrigerating items stored therein, cooler 100 may alternatively be used to store heated items. Whether used to store heated or refrigerated items, the insulated nature of housing 105 reduces the loss of heat from or the transfer of heat to, respectively, the items stored therein.

Housing 105 includes an outer housing 115 and an inner housing 120 disposed therein. Outer and inner housings 115, 120 are movable relative to one another. In preferred embodiments, inner housing 120 is movable relative to outer housing 115 between a fully retracted or stowed position, illustrated by FIG. 2, and a fully extended and accessible position, illustrated by FIG. 3. When in its fully extended position, inner housing 120 remains coupled to outer housing 115 to promote ease of returning inner housing 120 to the stowed position. In other embodiments, inner housing 120 may be completely detached from outer housing 115 once fully extended. Regardless, storage cavity 110 is accessible through a closeable opening 125 (FIG. 2) in outer housing 115 when inner housing 120 assumes the stowed position and through an opening 130 (FIG. 3) in inner housing 120 when inner housing 120 is extended relative to outer housing 115.

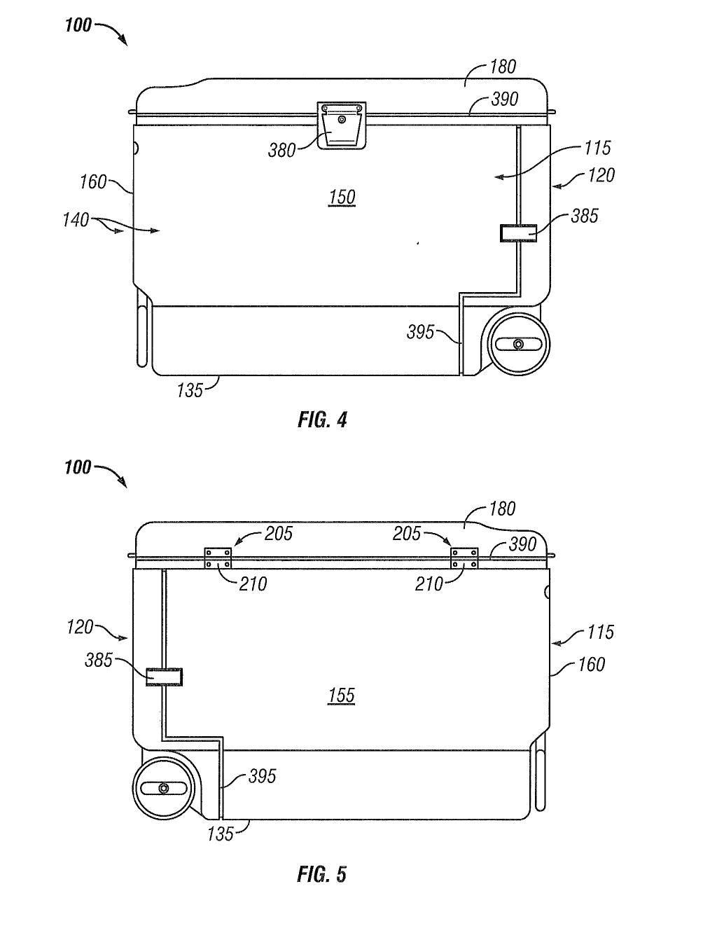

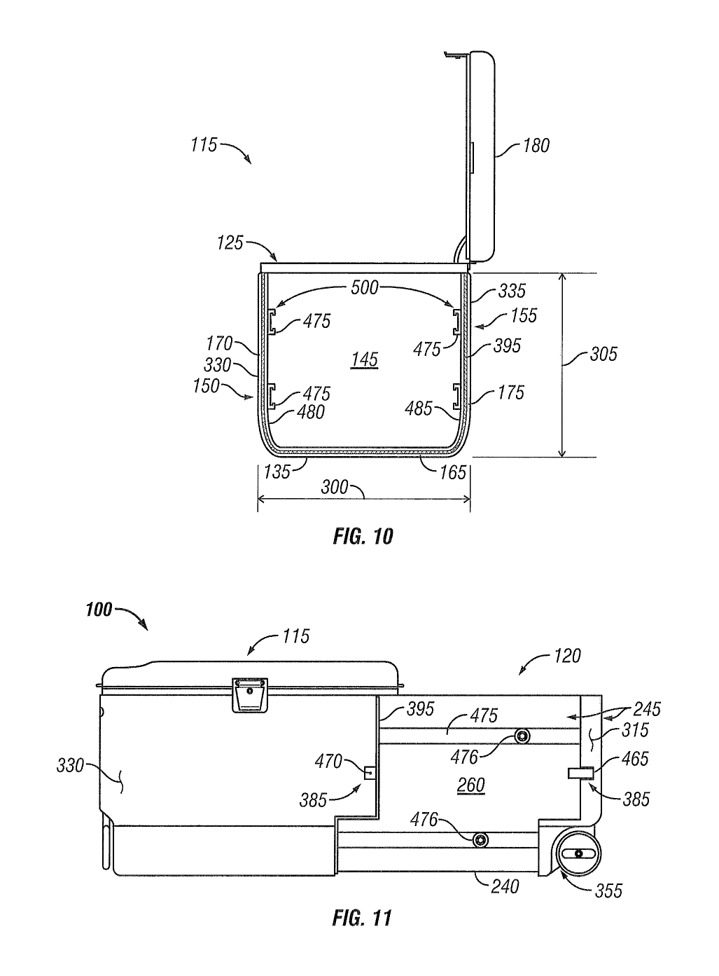

FIGS. 4 through 10 depict cooler 100, outer housing 115 or the end of inner housing 120 from various directions. As shown in these figures, outer housing 115 includes a base 135 and three walls 140 extending substantially normally therefrom. Base 135 and walls 140 form an interior cavity 145 (FIG. 10) that receives inner housing 120. Walls 140 include a front wall 150, a rear wall 155 opposite front wall 150, and a side, lateral or end wall 160 extending therebetween. Base 135, front wall 150, and rear wall 155 have end surfaces 165, 170, 175, respectively, as best viewed in FIG. 10. When inner housing 120 is disposed within outer housing 115 in the stowed position, inner housing 120 abuts end surfaces 165, 170, 175 of base 135, front wall 150, and rear wall 155, respectively, as illustrated by FIGS. 4 and 5.

Referring to FIG. 2, outer housing 115 further includes a removable top or lid 180. When inner housing 120 is in the stowed position, opening 125 is formed by the interior edges of upper surfaces 190, 185, 195, 200 of end wall 160, rear wall 155, front wall 150, and inner housing 120, respectively. Lid 180 is operable to engage upper surfaces 185, 190, 195, 200 of rear wall 155, end wall 160, front wall 150, and inner housing 120, when in its stowed position, to cover opening 125 and thus prevent access to storage cavity 110. When so engaged, lid 180 is closed or in a closed position. Lid 180 is also operable to disengage rear wall 155, end wall 160, front wall 150, and inner housing 120 to enable access to storage cavity 110 through opening 125. When so disengaged, lid 180 is open or in an open position.

In preferred embodiments, lid 180 is coupled to rear wall 155 via two coupling means 205, both visible in FIG. 5. Coupling means 205 ensure that lid 180 remains joined with the remainder of cooler 100, and hence cannot be misplaced. At the same time, coupling means 205 do not inhibit lid 180 from moving freely between the open and closed positions. In the illustrated embodiment, coupling means 205 includes two hinges 210, each hinge 210 connected between lid 180 and rear wall 155. In other embodiments, coupling means 205 may include two similarly connected straps or other equivalent types of connections.

Alternatively, lid 180 may not include coupling means 205, allowing lid 180 to completely detach from the remainder of cooler 100 when opened. Instead, lid 180 may be formed such that it includes a lip extending substantially normally from its interior surface 215 that is received within opening 125 when lid 180 is closed and removable from opening 125 when lid 180 is opened. The lip enables a snug fit within opening 125 such that lid 180 “snaps” closed and is prevented from inadvertently opening yet not so snug that lid 180 cannot be opened when desired.

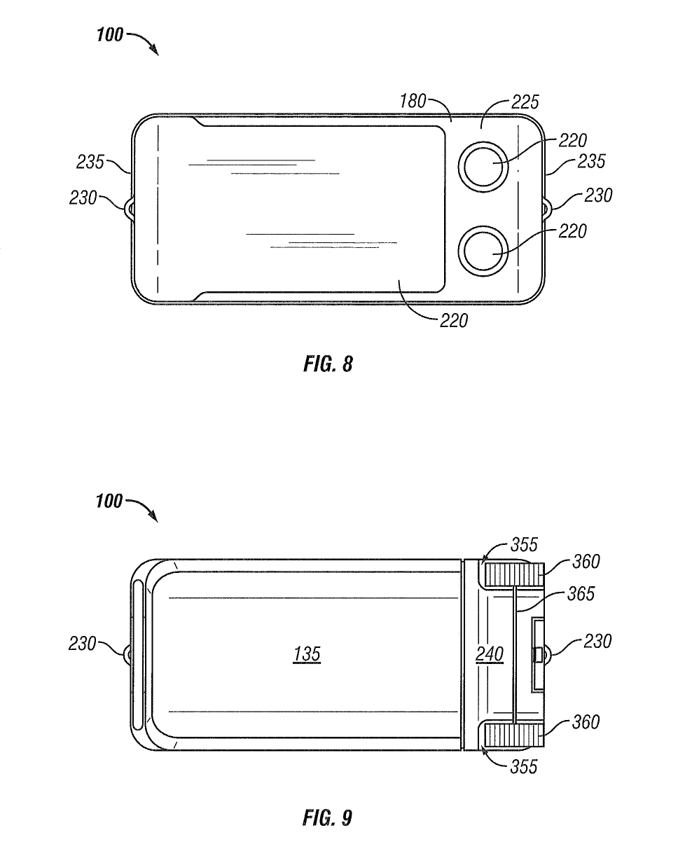

Referring to FIG. 8, which is a top view of cooler 100, lid 180 may optionally include one or more recesses 220 formed in an exterior, top surface 225 and two extensions 230, each formed along, or coupled to, opposing exterior, end surfaces 235 of lid 180. Recesses 220 may be shaped to receive a beverage container and/or provide a working surface to enable use of items retrieved from cooler 100. Extensions 230 may be gripped to enable opening of lid 180. Recesses 220 and extensions 230 are also visible in FIG. 1.

FIGS. 3, 11, and 12 depict cooler 100 or inner housing 120 from various directions. Referring to these figures, inner housing 120 includes a base 240 and four walls 245 extending substantially vertically therefrom. Base 240 and walls 245 form storage cavity 110, previously described and best viewed in FIG. 3. Interior surfaces of base 240 and walls 245 bounding storage cavity 110 are coated with a moisture resistant sealant 505 to prevent leakage of moisture, e.g., melted ice, through base 240 and walls 245.

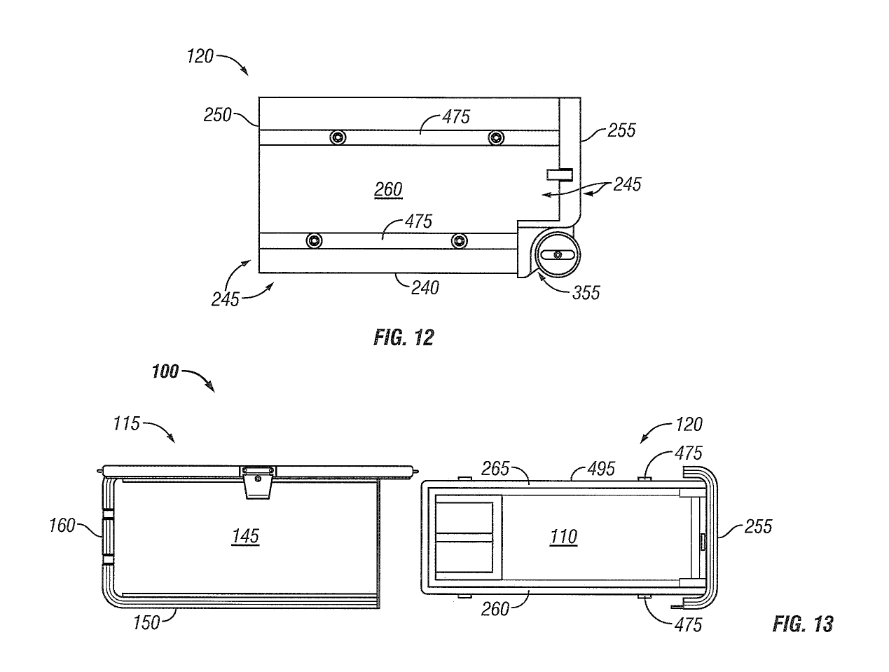

Walls 245 include an interior end wall 250 (FIG. 12), an exterior end wall 255 disposed opposite interior end wall 250, a front wall 260, and a rear wall 265 disposed opposite front wall 260. When inner housing 120 is disposed within outer housing 115 in the stowed position, base 240, interior end wall 250, front wall 260, and rear wall 265 of inner housing 120 are received within cavity 145 (FIG. 10) of outer housing 115 with exterior end wall 255 of inner housing 120 abutting previously described end surfaces 165, 170, 175 of base 135, front wall 150, and rear wall 155 of inner housing 115. FIG. 1 illustrates inner housing 120 disposed within outer housing 115 in the stowed position with end wall 255 abutting inner housing 115.

As illustrated by FIG. 3, base 240 and walls 260, 265 coupled thereto of inner housing 120 have an exterior width 270 and an exterior height 275. Width 270 and height 275 are selected to enable inner housing 120 to be received within interior cavity 145 (FIG. 10) of outer housing 115 with lid 180 closed, yet provide minimal clearance between outer housing 115 and inner housing 120 disposed therein to maximize the volume of storage cavity 110.

Exterior end wall 255 of inner housing 120 has a width 280, a height 285, and an interior surface 290. Width 280 and height 285 exceed width 270 and height 275, respectively, of base 240 and walls 260, 265 coupled thereto. As such, a shoulder 295 is formed by the periphery of exterior end wall 255 proximate base 240 and walls 260, 265. When inner housing 120 is in its stowed position, shoulder 295 of exterior end wall 255 abuts previously described end surfaces 165, 170, 175 of base 135, front wall 150, and rear wall 155, respectively, of outer housing 115.

Moreover, width 280 and height 285 of exterior end wall 255 are substantially equal to an exterior width 300 (FIG. 10) and an exterior height 305 (FIG. 10) of base 135 and walls 150, 155 coupled thereto of outer housing 115. Consequently, when inner housing 120 assumes the stowed position, exterior top surface 310 of exterior end wall 255 is substantially flush with previously described upper surfaces 185, 195 of rear and front walls 155, 150, respectively, of inner housing 115. This enables lid 180 to close when inner housing 120 is stowed within outer housing 115. Further, front, rear, and base surfaces 315, 320, 325, respectively, of exterior end wall 255 are substantially flush with exterior surfaces 330, 335 (FIG. 10), 340 of lid 180, front wall 150, rear wall 155, and base 135, respectively, of outer housing 115.

Referring still to FIG. 3, exterior end wall 255 includes a drain port 345, which extends through end wall 255 between its interior and exterior surfaces 290, 350, respectively. Drain port 345 is selectably openable and closeable. When open, drain port 345 enables the drainage of fluid, e.g., melted ice, from storage cavity 110. When closed, the drainage of fluid from storage cavity 110 through port 345 is prevented.

Base 240 and exterior end wall 255 of inner housing 120 are molded, or otherwise formed, to create an exterior recess 355. Cooler 100 further includes two wheels 360 coupled via an axel 365 to base 240, as best viewed in FIG. 9. Wheels 360 enable cooler 100 to move when pulled. Further, wheels 360 are preferably sized and positioned such that their outer circumference is flush with exterior surface 340 of base 135 of outer housing 115. This enables cooler 100 to remain level when positioned on a substantially flat surface regardless of the position of inner housing 120 relative to outer housing 115. Also, this enables ease of movement of inner housing 120 relative to outer housing 115.

Referring again to FIG. 2, inner housing 120 may optionally include one or more storage bins or shelves 510 supported within storage cavity 110. Bins 510 enable items to be stored within cooler 100 separately from others. For example, foodstuffs that are preferably kept dry may be placed in bins 510, while canned beverages may be buried in ice below bins 510. Further, each bin 510 may be subdivided by one or more dividers 515, enabling organization of items stored therein.

When inner housing 120 is extended relative to outer housing 115, items stored in bins 510 and storage cavity 110 are accessible through opening 130 (FIG. 3). Thus, inner housing 120 forms an extendable drawer system that enables access to foodstuffs and/or other items stored therein without the need to open lid 180 of cooler 100. Consequently, an object supported on, or individual seated on, closed lid 180 need not be removed from lid 180 to enable access to items stored in cooler 100.

In preferred embodiments, cooler 100 further includes a means 370 for pulling cooler 100 such that cooler 100 rolls via wheels 360, means 375 for lifting cooler 100, latches 380, 385, sealing members 390, 395, and drawer slides 475. In some embodiments, pulling means 370 is a handle, best viewed in FIG. 7, coupled to an exterior surface 400 of end wall 160 via pinned connections 405 that enable the handle to rotate or pivot relative to end wall 160 about an axis of pinned connections 405 that is substantially parallel to exterior surface 400. Pulling handle 370 has a length that enables an individual, regardless of his or her height, to pull cooler 100 (via wheels 360) without stooping or tripping due to inadvertent contact with end wall 160.

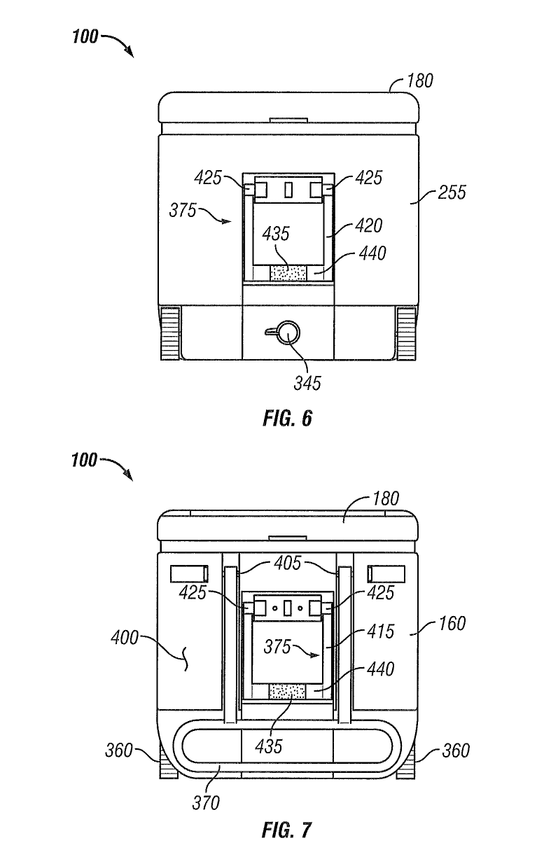

In some embodiments, lifting means 375 includes a first lifting means 415 disposed on end wall 160 of outer housing 115, as shown in FIG. 7, and a second, substantially identical lifting means 420 disposed on exterior end wall 255 of inner housing 120 opposite first lifting means 415, as shown in FIG. 6. The relative positioning of lifting means 415, 420 promotes ease of lifting cooler 100.

In the illustrated embodiment, first lifting means 415 is a handle coupled to end wall 160 via pinned connections 425 that enable the handle to rotate or pivot about an axis of pinned connections 425 that is substantially parallel to exterior end surface 400 of end wall 160. Lifting handle 415 is shorter than pulling handle 370 such that movement of one is not inhibited by the other. Moreover, lifting handle 415 may include a pad 435 comprising foam, or other type of cushioning material, over its gripping region 440 to promote comfort when lifting and carrying cooler 100. Second lifting means 420 is substantially identical in design and function to that of first lifting means 415, but is instead coupled to exterior end wall 255. Alternatively, lifting means 415, 420 may be handles that are not rotatable or pivotable relative to end walls 160, 255, respectively, recesses formed in end walls 160, 255, or other equivalent means that enable gripping and lifting of cooler 100.

Referring to FIG. 2, latch 380 enables lid 180 to be selectably locked in the closed position, thereby preventing inadvertent or unwelcome access through opening 125 to storage cavity 110. When lid 180 is closed and latch 380 is selectably locked, latch 380 retains lid 180 in the closed position until unlocked. When latch 380 is selectably unlocked, latch 380 no longer prevents lid 180 from opening. Latch 380 may be any type of latch known in the industry that enables this functionality. In the exemplary embodiment, latch 380 includes a locking member 450 coupled to a front surface 455 of lid 180 and a receptacle member (preferably recessed and thus not visible in FIG. 2) coupled to surface 330 of front wall 150. When lid 180 is closed and locking member 450 is received within the receptacle member, latch 380 is locked and lid 180 is prevented from opening. When locking member 450 is disengaged from the receptacle member, latch 380 is unlocked and lid 180 is free to open.

Referring now to FIGS. 4, 5, and 11, latches 385 enable inner housing, or drawer system, 120 to be selectably locked to outer housing 115 when drawer system 120 is in the stowed position, thereby preventing inadvertent or unwelcome access through opening 130 of drawer system 120 to storage cavity 110. When drawer system 120 is in the stowed position and latches 385 are selectably locked, latches 385 retain drawer system 120 in its stowed position, preventing drawer system 120 from extending relative to outer housing 115. When latches 385 are selectably unlocked, latches 385 no longer prevent drawer system 120 from extending relative to outer housing 115.

Latches 385 may be any type of latch known in the industry that enables this functionality. In the exemplary embodiment, one latch 385 includes a locking member 465 (FIG. 11) coupled to surface 315 of exterior end wall 255 of drawer system 120 and a receptacle member 470 coupled to surface 330 of front wall 150 of outer housing 115. The other, substantially identical latch 385 includes a locking member 465 coupled to surface 320 of end wall 255 and receptacle member 470 coupled to surface 335 of rear wall 155 of outer housing 115. When drawer system 120 is in the stowed position and each locking member 465 is received within its respective receptacle member 470, latches 385 are locked and drawer system 120 is prevented from extending relative to outer housing 115. When locking members 465 are disengaged from receptacle members 470, latches 385 are unlocked and drawer system 120 is free to move relative to outer housing 115.

Sealing member 390, best viewed in FIGS. 2 and 4, reduces heat transfer at interfaces between lid 180 and rear wall 155, end wall 160, and front wall 150 of outer housing 115 and end wall 255 of inner housing 120. Sealing member 390 is disposed on the upper surfaces 185, 190, 195, 200 of rear wall 155, end wall 160, front wall 150, and end wall 255, respectively, circumscribing opening 125 and/or along that portion of interior surface 215 of lid 180 that engages these surfaces when lid 180 is closed. Sealing member 390 enables sealing engagement between lid 180 and walls 150, 155, 160, 255 when lid 180 is closed. In some embodiments, sealing member 390 is an O-ring.

Similarly, sealing member 395, best viewed in FIGS. 10 and 11, reduces heat transfer at interfaces between drawer system 120 and outer housing 115. Sealing member 395 is disposed along end surfaces 165, 170, 175 of base 135, front wall 150, and rear wall 150, respectively, of outer housing 115 and/or along shoulder 295 of exterior end wall 255 of drawer system 120. Sealing member 395 enables sealing engagement between drawer system 120 and outer housing 115 when drawer system 120 is in its stowed position. In some embodiments, sealing member 390 is an O-ring.

Referring lastly to FIGS. 10 through 13, cooler 100 includes one or more pairs 500 of drawer slides 475 to promote movement of drawer system 120 relative to outer housing 115. Each pair 500 includes one drawer slide 475 coupled between an interior surface 480 of front wall 150 of outer housing 115 and an exterior surface 490 of front wall 260 of drawer system 120 and another drawer slide 475 coupled between an interior surface 485 of rear wall 155 of outer housing 115 and an exterior surface 495 of rear wall 265 of drawer system 120. The positioning of drawer slides 475 is selected to promote smooth movement of drawer system 120 relative to outer housing 115. In some embodiments, cooler 100 includes at least two pairs 500 of drawer slides 475 to ensure adequate load capacity when storage cavity 110 is full. Further, in some embodiments, drawer system 120 is detachable from inner housing 115 when drawer system 120 is fully extended to enable cleaning of cooler 100, as illustrated by FIG. 13.

While various embodiments have been shown and described, modifications thereof can be made by one skilled in the art without departing from the spirit and teachings herein. The embodiments herein are exemplary only, and are not limiting. Many variations and modifications of the apparatus disclosed herein are possible and within the scope of the invention. Accordingly, the scope of protection is not limited by the description set out above, but is only limited by the claims which follow, that scope including all equivalents of the subject matter of the claims.

What is claimed is:

1. A system for storing refrigerated or heated items, the system comprising:
an insulated housing having an exterior base, four exterior walls extending substantially normally to the exterior base, and a lid, wherein the four exterior walls include an exterior front wall, an exterior rear wall opposite the exterior front wall, an first exterior end wall extending between the exterior front and rear walls, and a second exterior end wall opposite the first exterior end wall; and
a storage cavity disposed within the insulated housing, the storage cavity containing the refrigerated or heated items;
wherein the lid is moveable to expose a first opening through which the storage cavity is accessible; and
wherein the second exterior end wall is moveable relative the exterior base, the exterior front wall, and the exterior rear wall to expose a second opening through which the storage cavity is accessible.

2. The system of claim 1, wherein the lid is coupled to the exterior rear wall of the insulated housing such that when the lid is moved to expose the first opening, the lid remains coupled to the rear wall.

3. The system of claim 2, wherein the lid is coupled to the rear wall by a pair of hinges, each hinge connected to the lid and to the exterior rear wall.

4. The system of claim 2, further comprising a latch coupled between the lid and the exterior front wall, the latch selectably actuatable between a locked configuration, wherein movement of the lid relative to the exterior front wall is prevented, and an unlocked configuration, wherein the lid is moveable relative to the exterior front wall.

5. The system of claim 1, further comprising:
a interior base extending substantially normally from the second exterior end wall;
an interior front wall extending substantially normally from the second exterior end wall and from the interior base;
an interior rear wall extending between the interior base and the second exterior end wall substantially parallel to the interior front wall; and
an interior end wall extending between the interior front wall and the interior rear wall;
wherein the interior base, the interior front wall, the interior rear wall, the interior end wall, and the second exterior end wall form the storage cavity.

6. The system of claim 5, wherein the first opening is defined by the four exterior walls and wherein the second opening is bounded by the interior front wall, the interior rear wall, the interior end wall, and the second exterior end wall.

7. The system of claim 1, further comprising a pair of wheels coupled to the base of the insulated housing and a handle pivotably coupled to the first end wall.

8. The system of claim 1, further comprising a first handle coupled to the first end wall and a second handle coupled to the second end wall, the first and second handles pivotable relative to the insulated housing to enabling lifting of the insulated housing and the items stored therein.

9. The system of claim 1, further comprising a closeable drain port extending through the second end wall.

10. The system of claim 1, further comprising a pair of latches, one latch coupled between the second exterior end wall and the exterior front wall and the other latch coupled between the second exterior end wall and the exterior rear wall, each of the latches selectably actuatable between a locked configuration, wherein movement of the second exterior end wall relative to the exterior front and rear walls is prevented, and an unlocked configuration, wherein movement of the second exterior end wall relative to the exterior front and rear walls is enabled.

11. A system for storing refrigerated or heated items, the system comprising:
an insulated housing including a lid movable between an open position and a closed position; and
a drawer system slideably disposed within the insulated housing and having a storage cavity receiving the refrigerated or heated items, wherein the drawer system is movable relative to the insulated housing between a stowed position and an extended position;
wherein the storage cavity is accessible when the lid is in the closed position and the drawer system is in the extended position.

12. The system of claim 11, wherein the drawer system further comprises one or more storage bins supported within the storage cavity.

13. The system of claim 11, further comprising a closeable drain port extending through a wall of the drawer system.

14. The system of claim 11, further comprising a pair of drawer slides coupled between the insulated housing and the drawer system, whereby the drawer system is slideable relative to the insulated housing between the stowed position and the extended position.

15. The system of claim 11, further comprising a pair of wheels coupled to a base of the drawer system, the wheels positioned such that the insulated housing remains substantially level when the drawer system is in the extended position, the stowed position, or another position therebetween.

16. The system of claim 11, wherein interior surfaces of the drawer system are coated with a moisture resistant sealant.

17. A system for storing refrigerated or heated items, the system comprising:
an insulated outer housing having a base, a lid opposite the base, a front wall, a rear wall opposite the front wall, and an end wall extending between the front and rears walls, wherein the lid is coupled to the rear wall and movable between an open position and a closed position;
an inner housing disposed within the outer housing, the inner housing having a base, a front wall, a rear wall opposite the front wall, an interior end wall extending between the front and rear walls, and an exterior end wall opposite the interior end wall, wherein the exterior end wall is insulated and wherein the base, the front wall, the rear wall, the interior end wall, and the exterior end wall define a storage cavity receiving the refrigerated or heated items; and
a pair of drawer slides coupled between the outer housing and the inner housing, whereby the inner housing is slideable relative to the outer housing between a stowed position and an extended position;
wherein the storage cavity is accessible when the lid is in the closed position and the inner housing is in the extended position.

18. The system of claim 17, wherein the inner housing further comprises one or more storage bins supported within the storage cavity.

19. The system of claim 17, wherein the front wall, the rear wall, the interior end wall, and the exterior end wall of the inner housing define a first opening through which the storage cavity is accessible when the inner housing is in the extended position and the lid is in the closed position.

20. The system of claim 17, wherein the drawer system further comprises a closeable drain port.
